(19) United States
(12) Patent Application Publication
(10) Pub. No.: US 2022/0256849 A1
(43) Pub. Date: Aug. 18, 2022

(54) IMPROVED BIOCIDE FORMULATIONS FOR THE PRESERVATION OF ANALYTE DETECTION SENSOR(S) AND METHOD(S) OF USE AND THEREOF

(71) Applicant: Siemens Healthcare Diagnostics Inc., Tarrytown, NY (US)

(72) Inventors: Murli Narayan, Norfolk, MA (US); Kevin Horan, Raynham, MA (US)

(73) Assignee: Siemens Healthcare Diagnostics Inc., Tarrytown, NY (US)

(21) Appl. No.: 17/597,866

(22) PCT Filed: Jul. 20, 2020
(86) PCT No.: PCT/US2020/042748

§ 371 Date: Jan. 27, 2022

Related U.S. Application Data
(60) Provisional application No. 62/880,990, filed on Jul. 31, 2019.

(51) Int. Cl. A01N 43/66

(52) U.S. Cl. CPC A01N 43/66

(57) ABSTRACT

Composition(s), device(s), kit(s), and method(s) for improved biocide formulations that remove contaminants (and the effects related thereto) from at least one analyte detection sensor, while simultaneously preserving and/or extending the functional life of the at least one analyte detection sensor.

### CROSS REFERENCE TO RELATED APPLICATIONS/INCORPORATION BY REFERENCE STATEMENT

This application claims benefit under 35 USC § 119(e) of provisional application U.S. Ser. No. 62/880,990, filed Jul. 31, 2019. The entire contents of the above-referenced patent application(s) are hereby expressly incorporated herein by reference.

### STATEMENT REGARDING FEDERALLY FUNDED RESEARCH OR DEVELOPMENT

Not Applicable.

### BACKGROUND

Numerous devices and methods exist for detecting analytes that may be present in a patient's biological fluid sample, including, for instance, a patient's blood, urine, serum, plasma, and/or cerebrospinal fluid sample. Such devices have been proven to be effective in diagnostic assays that detect the presence (or non-presence) as well as the quantity of certain analytes indicative of a patient's health and biological profile, including, but not limited to, analytes and conditions associated with a patient's biological fluid sample, such as, by way of example, a patient's blood and/or urine sample. For instance, blood gas, electrolyte, and/or metabolite analyzers (collectively, “BGAs”) have been used for years in the medical industry to determine the presence and concentration of certain analytes which may be present in a patient's blood sample. BGAs are routinely used by doctors, scientists, researchers, and medical-care professionals to determine the presence and/or concentrations of certain characteristics and/or analytes present in a patient's blood sample, including, without limitation: (1) blood gases (such as pH (acidity), carbon dioxide (measured as pCO₂—partial pressure of carbon dioxide), and/or oxygen (measured as pO₂—partial pressure of oxygen)); (2) electrolytes (such as sodium (Nat), potassium (K⁺), Calcium (Ca²⁺), and/or chloride (Cl⁻); (3) metabolites (such as glucose, lactate, biological urea nitrogen (BUN), and/or creatinine); and/or co-oximetry concentration measurements (such as total hemoglobin (tHb), reduced hemoglobin/deoxyhemoglobin (HHb), oxyhemoglobin (O₂Hb), saturated oxygen (sO₂), carboxyhemoglobin (COHb), methemoglobin (MetHb), fetal hemoglobin (HbF), and/or bilirubin).

BGAs rely on and comprise a sensor array having at least one analyte detection sensor, such as, by way of example only, at least one creatinine detection sensor, to accurately detect and/or quantify the analyte(s) of interest present in the patient's biological fluid sample. The consistent and continual functioning of the at least one analyte detection sensor (such as a creatinine detection sensor) is critical to the accurate detection and quantification of the analyte(s) of interest which may be present in the patient's biological fluid sample. In addition, improvements that preserve and increase the functional-life of such sensor(s) are highly desired.

To preserve the shelf-life and functionality of at least one analyte detection sensor(s), including, without limitation, creatinine detection sensor(s), at least one biocide may be used in combination with the reagent(s) for the detection of the analyte(s) of interest. However, some of these biocides and/or preservatives (such as, by way of example, via the biocide(s) diffusing through a sensor cover membrane) can deactivate critical enzymes necessary for performing the various assays associated with the analyte detection sensor(s), resulting in loss of sensor functionality and/or deterioration of the functional life of the analyte detection sensor(s).

Accordingly, a need exists for new and improved compositions, devices, kits, and methods that preserve or increase the functional life of sensors used to detect and quantify analyte(s) of interest which may be present in a patient's biological fluid sample. Such new and improved compositions, devices, kits, and methods thereby allow, by way of example and not by way of limitation, for: (1) the accurate detection of at least one analyte(s) of interest which may be present in a patient's biological fluid sample; (2) at least the preservation, if not an increase, in the functional life of the analyte detection sensor(s); and (3) cost and time savings due to the re-usability of the of the analyte detection sensor(s). It is to such compositions, devices, and methods, as well as kits related thereto, that the presently disclosed and/or claimed inventive concept(s) is directed.

### BRIEF DESCRIPTION OF THE SEVERAL VIEWS OF THE DRAWINGS

FIG. 1 is a perspective view of a non-limiting embodiment of an improved analyte detection sensor constructed in accordance with the presently disclosed and/or claimed inventive concept(s).

FIG. 2 is a cross-sectional view of the improved analyte detection sensor of FIG. 1 as viewed from the cross-sectional line x of FIG. 1 in which the improved analyte detection sensor is in fluid communication with at least one aqueous biocide.

FIG. 3 is a graphical plot showing the concentrations (measured in CFU per milliliter) of various contaminants (y-axis), such as, by way of example only, bacteria and fungi, over a period of time in weeks (x-axis) on plates treated with a concentration of about 20 ppm hexahydro 1,3,5-tris(2-hydroxy ethyl)-S-triazine (“Onyxide200”) biocide in accordance with the presently disclosed and/or claimed inventive concept(s).

FIG. 4A is a graphical plot showing the concentrations (measured in CFU per milliliter) of various contaminants (y-axis), such as, by way of example only, bacteria and fungi, over a period of time in weeks (x-axis) on plates treated with a concentration of about 5 ppm of 5-chloro-2-methylisothiazol-3(2H)-one (“CI-MIT”) biocide in accordance with the presently disclosed and/or claimed inventive concept(s).

FIG. 4B is a graphical plot showing the concentrations (measured in CFU per milliliter) of various contaminants (y-axis), such as, by way of example only, bacteria and fungi, over a period of time in weeks (x-axis) on plates treated with a concentration of about 1 ppm of CI-MIT biocide in accordance with the presently disclosed and/or claimed inventive concept(s).

FIG. 5A is a graphical plot showing the concentrations (measured in CFU per milliliter) of various contaminants (y-axis), such as, by way of example only, bacteria and fungi, over a period of time in weeks (x-axis) on plates treated with a combination of concentrations of about 20 ppm of Onyxide200 biocide and about 4 ppm of CI-MIT biocide in accordance with the presently disclosed and/or claimed inventive concept(s).

FIG. 5B is a graphical plot showing the concentrations (measured in CFU per milliliter) of various contaminants (y-axis), such as, by way of example only, bacteria and fungi, over a period of time in weeks (x-axis) on plates treated with a combination of concentrations of about 20 ppm of Onyxide200 biocide and about 3 ppm of CI-MIT biocide in accordance with the presently disclosed and/or claimed inventive concept(s).

FIG. 5C is a graphical plot showing the concentrations (measured in CFU per milliliter) of various contaminants (y-axis), such as, by way of example only, bacteria and fungi, over a period of time in weeks (x-axis) on plates treated with a combination of concentrations of about 20 ppm of Onyxide200 biocide and about 2 ppm of CI-MIT biocide in accordance with the presently disclosed and/or claimed inventive concept(s).

FIG. 5D is a graphical plot showing the concentrations (measured in CFU per milliliter) of various contaminants (y-axis), such as, by way of example only, bacteria and fungi, over a period of time in weeks (x-axis) on plates treated with a combination of concentrations of about 20 ppm of Onyxide200 biocide and about 1 ppm of CI-MIT biocide in accordance with the presently disclosed and/or claimed inventive concept(s).

FIG. 5E is a graphical plot showing the concentrations (measured in CFU per milliliter) of various contaminants (y-axis), such as, by way of example only, bacteria and fungi, over a period of time in weeks (x-axis) on plates treated with a combination of concentrations of about 20 ppm of Onyxide200 biocide and about 0.5 ppm of CI-MIT biocide in accordance with the presently disclosed and/or claimed inventive concept(s).

### DETAILED DESCRIPTION

Before explaining at least one embodiment of the inventive concept(s) in detail by way of exemplary drawings, experimentation, results, and laboratory procedures, it is to be understood that the inventive concept(s) is not limited in its application to the details of construction and the arrangement of the components set forth in the following description or illustrated in the drawings, experimentation and/or results. The inventive concept(s) is capable of other embodiments or of being practiced or carried out in various ways. As such, the language used herein is intended to be given the broadest possible scope and meaning; and the embodiments are meant to be exemplary—not exhaustive. Also, it is to be understood that the phraseology and terminology employed herein is for the purpose of description and should not be regarded as limiting.

Unless otherwise defined herein, scientific and technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular. The foregoing techniques and procedures are generally performed according to conventional methods well known in the art and as described in various general and more specific references that are cited and discussed throughout the present specification. The nomenclatures utilized in connection with, and the laboratory procedures and techniques of, analytical chemistry, synthetic organic chemistry, and medicinal and pharmaceutical chemistry described herein are those well-known and commonly used in the art.

All patents, published patent applications, and non-patent publications mentioned in the specification are indicative of the level of skill of those skilled in the art to which this presently disclosed and/or claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the compositions, devices, kits, and/or methods disclosed and/or claimed herein can be made and executed without undue experimentation in light of the present disclosure. While the compositions and methods of this presently disclosed and/or claimed inventive concept(s) have been described in terms of particular embodiments, it will be apparent to those of skill in the art that variations may be applied to the compositions and/or methods and in the steps or in the sequence of steps of the method described herein without departing from the concept, spirit and scope of the presently disclosed and/or claimed inventive concept(s). All such similar substitutes and modifications apparent to those skilled in the art are deemed to be within the spirit, scope, and concept of the inventive concept(s) as defined by the appended claims.

As utilized in accordance with the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The singular forms “a,” “an,” and “the” include plural referents unless the context clearly indicates otherwise. Thus, for example, reference to “a compound” may refer to 1 or more, 2 or more, 3 or more, 4 or more or greater numbers of compounds. The term “plurality” refers to “two or more.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects. For example but not by way of limitation, when the term “about” is utilized, the designated value may vary by ±20% or ±10%, or ±5%, or ±1%, or ±0.1% from the specified value, as such variations are appropriate to perform the disclosed methods and as understood by persons having ordinary skill in the art. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used in this specification and claim(s), the terms “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree. For example, the term “substantially” means that the subsequently described event or circumstance occurs at least 90% of the time, or at least 95% of the time, or at least 98% of the time.

As used herein, the phrase “associated with” includes both direct association of two moieties to one another as well as indirect association of two moieties to one another. Non-limiting examples of associations include covalent binding of one moiety to another moiety either by a direct bond or through a spacer group, non-covalent binding of one moiety to another moiety either directly or by means of specific binding pair members bound to the moieties, incorporation of one moiety into another moiety such as by dissolving one moiety in another moiety or by synthesis, and coating one moiety on another moiety.

The terms “biocide,” “biocidal composition,” “microbicide,” and “microbicidal composition” refer to a preservative composition that can substantially inhibit the growth of and/or kill microbes. For the purposes of this description, “microbes” may include bacteria, mold, yeast and/or viruses. Particular examples of microbes may include, but are not limited to, Pseudomonas fluorescens, Pseudomonas putida, Pseudomonas aeruginosa, Ralstonia pickettii, Gram positive rods, Aspergillus glaucus, and Penicillium notatum. The terms “biocide,” “biocidal composition,” “microbicide,” and “microbicidal composition” will be understood to include any substance or combination of substances, including, without limitation, preservatives, antimicrobial agents (including, but not limited to, germicides, antibiotics, antibacterials (including, bactericides), antivirals, antifungals, antiprotozoals, and/or antiparasites), anti-fouling agents, disinfectants, and/or pesticides (including, but not limited to, fungicides, herbicides, insecticides, algicides, molluscicides, miticides, and/or rodenticides) which are used for the control of organisms that are harmful to human and/or animal health and/or that cause damage to natural or manufactured products. The biocides/biocidal compositions, as used herein, can be in any form, including, without limitation, aqueous (i.e., a fluid) or solid (i.e., a powder).

The term “biological fluid sample” as used herein will be understood to include any type of biological fluid sample that may be utilized in accordance with the presently disclosed and/or claimed inventive concept(s). Examples of biological fluid samples that may be utilized include, but are not limited to, whole blood or any portion thereof (i.e., plasma or serum), saliva, sputum, cerebrospinal fluid (CSF), intestinal fluid, intraperitoneal fluid, cystic fluid, sweat, interstitial fluid, tears, mucus, urine, bladder wash, semen, combinations, and the like. In one non-limiting embodiment, the biological fluid sample utilized in accordance with the presently disclosed and/or claimed inventive concept(s) is blood. The volume of the biological fluid sample utilized in accordance with the presently disclosed and/or claimed inventive concept(s) can be from about 0.1 microliter to about 300 microliters, or from about 0.5 microliter to about 290 microliters, or from about 1 microliter to about 280 microliters, or from about 2 microliters to about 270 microliters, or from about 5 microliters to about 260 microliters, or from about 10 microliters to about 260 microliters, or from about 15 microliters to about 250 microliters, or from about 20 microliters to about 250 microliters, or from about 30 microliters to about 240 microliters, or from about 40 microliters to about 230 microliters, or from about 50 microliters to about 220 microliters, or from about 60 microliters to about 210 microliters, or from about 70 microliters to about 200 microliters, or from about 80 microliters to about 190 microliters, or from about 90 microliters to about 180 microliters, or from about 100 microliters to about 170 microliters, or from about 110 microliters to about 160 microliters, or from about 120 microliters to about 150 microliters, or from about 130 microliters to about 140 microliters. In one non-limiting embodiment, the volume of the fluid sample is in a range of from about 100 microliters to about 200 microliters.

The term “circuitry” as used herein includes, but is not limited to, analog and/or digital components, or one or more suitably programmed processors (e.g., microprocessors) and associated hardware and software or hardwired logic. The term “component” may include hardware, such as but not limited to, a processor(s) (e.g., microprocessor(s)), an application specific integrated circuit (ASIC), field programmable gate array (FPGA), a combination of hardware and software, and/or the like. The term “software” as used herein may include one or more computer readable medium (i.e., computer readable instructions) that when executed by one or more components cause the component to perform a specified function. It should be understood that the algorithms described herein may be stored on one or more non-transient memory. Non-limiting exemplary non-transient memory may include random access memory, read only memory, flash memory, and/or the like. Such non-transient memory may be electrically-based, optically-based, and/or the like.

The term “contaminant(s)” as used herein refers to any biological substance(s), non-biological substance(s), and/or combinations thereof that is/are capable of either reducing the accuracy of analyte detection measurements, reduces the analyte detection sensor shelf-life, and/or detrimentally impacts and/or destroys the functionality of the at least one analyte detection sensor, such as, by way of example, an amperometric enzyme sensor, including, without limitation, a creatinine enzyme detection sensor. Contaminant(s) include, by way of example only, and not by limitation: (1) bacteria, including, without limitation, Staphylococcus aureus, Escherichia coli, Pseudomonas aeruginosa, Carnobacterium maltaromaticum, and combinations thereof; (2) fungi, including, without limitation, Candida albicans, Aspergillus niger, various species of Penicillium, and combinations thereof; (3) biocide(s), including, without limitation, CI-MIT; and (4) any combination(s) of any of (1)-(3) above.

The term “patient” includes human and veterinary subjects. In certain embodiments, a patient is a mammal. In certain other embodiments, the patient is a human, including, but not limited to, infants, toddlers, children, young adults, adults, and elderly human populations. “Mammal” for purposes of treatment refers to any animal classified as a mammal, including human, domestic and farm animals, nonhuman primates, and zoo, sports, or pet animals, such as dogs, horses, cats, cows, etc.

The terms “peptide,” “polypeptide,” and “protein” are used herein to refer to a polymer of amino acid residues. The term “polypeptide” as used herein is a generic term to refer to native protein, protein fragments, or analogs of a polypeptide sequence. Hence, native protein, protein fragments, and analogs are species of the polypeptide genus. In one non-limiting embodiment of the presently disclosed and/or claimed inventive concept(s), the peptide(s), polypeptide(s), protein(s), and/or polymer(s) comprise thiol(s) and/or thiol-containing constituents.

The term “biosensor” refers to a type of analyte detection sensor that combines a biological component with a physicochemical detector component. The biosensor comprises a biological component, such as but not limited to, enzymes, antibodies, tissue, microorganisms, organelles, cell receptors, nucleic acids, etc. For example, but not by way of limitation, the biosensors utilized in accordance with the presently disclosed and/or claimed inventive concept(s) may be creatinine, blood urea nitrogen (BUN), glucose, lactate, etc.

As used herein, the phrase “does not substantially affect the biological activity of a sensor” means that a substantial amount of the sensor's biological (enzymatic) activity and stability is retained. For example but not by way of limitation, at least 30% of the biological activity of the sensor is retained, at least 40% of the biological activity of the sensor is retained, at least 50% of the biological activity of the sensor is retained, at least 60% of the biological activity is retained, at least 70% of the biological activity is retained, at least 80% of the biological activity is retained or at least 90% of the biological activity is retained. In addition, enzyme stability of the biosensor is substantially retained, whereby the enzyme stability of the biosensor extends for (for example but not by way of limitation) more than 4 days, more than 6 days, more than 8 days, more than 10 days, more than 12 days, more than 14 days, more than 20 days, more than 25 days, or more than 28 days.

Turning now to particular embodiments, the presently disclosed and/or claimed inventive concept(s) relate to a composition(s), device(s), kit(s), and method(s) for improving biocide formulation(s) for use in at least one analyte(s) detection sensor(s) and/or diagnostic assay(s). More specifically, in one non-limiting embodiment, the presently disclosed and/or claimed inventive concept(s) relate to an improved biocide formulation(s) that comprises and/or consists of at least two biocide compositions that synergistically work together to mitigate and/or inhibit the inactivation of at least one enzyme(s) which may be present on and/or in at least one sensor(s) utilized for analyte(s) detection, such as, by way of example only, a creatinine detection sensor. In addition, the improved biocide formulation increases the shelf-life of the at least one analyte(s) detection sensor(s).

In certain non-limiting embodiments, the presently disclosed and/or claimed inventive concept(s) relates to a composition(s), device(s), kit(s), and method(s) for preserving and/or improving the functional life and performance of at least one analyte detection sensor(s) of blood gas, electrolyte, and/or metabolite instrumentation. While a patient's biological fluid sample is primarily discussed herein in the context of a patient's blood sample, it should be readily understood by a person having ordinary skill in the art that the presently disclosed and/or claimed inventive concepts have applications to all types of a patient's biological fluid sample. More specifically, the presently disclosed and/or claimed inventive concept(s) relate to composition(s), device(s), kit(s), and method(s) for improving the functional life and performance of at least one amperometric enzyme sensor for the detection of one or more analytes of interest present within a patient's biological fluid sample. As discussed in greater detail herein, in one non-limiting embodiment of the presently disclosed and/or claimed inventive concept(s), the at least one amperometric enzyme sensor comprises and/or consists of at least one creatinine sensor(s) utilized in concert with or within a blood gas, electrolyte, and/or metabolite instrumentation.

Biocides are often used to preserve the at least one analyte detection sensor(s) of a sensor array present in a blood gas, electrolyte, and/or metabolite instrument. However, when such analyte detection sensor(s) is a creatinine detection sensor(s), these biocides inactivate some or all of the enzymes present on and/or in the creatinine sensor(s). In the context of creatinine sensors, such sensors rely on enzymes containing free sulfhydryl groups (—SH) for the proper and continuous functioning of the sensors. Such free sulfhydryl groups chemically react with certain species of biocide(s) (such as, CI-MIT) that result in the inactivation of the creatinine sensor's(s') enzymes, thereby resulting in decreased (or total loss) of functional utility and/or functional life of the creatinine sensor(s). Such inactivation can occur very rapidly. In some instances, inactivation of the creatinine sensor(s) may occur as soon as one (1) to four (4) days after exposure of the creatinine sensor(s) (i.e., sensor enzymes) to such biocide(s) species.

Non-limiting examples of enzymes utilized in accordance with the presently disclosed and/or claimed inventive concept(s) include, without limitation, enzymes for the detection of creatinine, such as, by way of example only, creatininase, creatinase, sarcosine oxidase, and combinations thereof—however, it should be readily understood by a person having ordinary skill in the art that the presently disclosed and/or claimed inventive concept(s) are not limited to these specific enzymes and that any enzyme(s) applicable to creatinine-based and/or other analyte detection sensors can be utilized in accordance with the scope of the presently disclosed and/or claimed inventive concept(s).

Non-limiting examples of biocides utilized in accordance with the presently disclosed and/or claimed inventive concept(s) include, without limitation, methylisothiazolinone (“MIT”); Proclin™ 300, which comprises a combination of CI-MIT, MIT, proprietary glycol, and modified alkyl carboxylate, and which is commercially offered for sale by Sigma-Aldrich Corporation and/or the Dow Chemical Company; CI-MIT; Onyxide200; other isothiazolinone-derived biocide, such as, without limitation, octylisothiazolinone, dichlorooctylisothiaolinone, and/or butylbenzisothiazolinone; and combinations thereof—however, it should be readily apparent to a person having ordinary skill in the art that the presently disclosed and/or claimed inventive concept(s) are not limited to these specific biocides and that any biocide(s) applicable to creatinine-based and/or other analyte detection sensors can be utilized in accordance with the scope of the presently disclosed and/or claimed inventive concept(s).

In one non-limiting embodiment, the biocides utilized in accordance with the presently disclosed and/or inventive concept(s) comprise or consist of Onyxide200, CI-MIT, and combinations thereof. In one non-limiting embodiment, the combined volume of biocide(s) utilized in accordance with the presently disclosed and/or claimed inventive concept(s) comprises and/or consists of from about 100 milliliters to about 350 milliliters.

One aspect of the presently disclosed and/or claimed inventive concept(s) embodies an improved analyte detection sensor array. The improved analyte detection sensor array comprises and/or consists of at least one analyte detection sensor which is in fluid communication with a biocide preservation fluid. In one non-limiting embodiment, the improved analyte detection sensor array is well adapted for incorporation and use in blood gas, electrolyte, and/or metabolite instrumentation. The improved analyte detection sensor array may, in one non-limiting embodiment, be contained within a housing, for instance, a cartridge for use in a blood gas, electrolyte, and/or metabolite instrument. The improved analyte detection sensor array may comprise any number of analyte detection sensors in order to accomplish the presently disclosed and/or claimed inventive concept(s). For instance, by way of example only, the improved analyte detection sensor array may comprise 1, 2, 3, 4, 5, 6, 7, 8, 9, 10, 15, 20, 25, 30, 35, 40, 45, 50, 55, 60, 65, 70, 75, 80, 85, 90, 95, or greater than or equal to 100 analyte detection sensors.

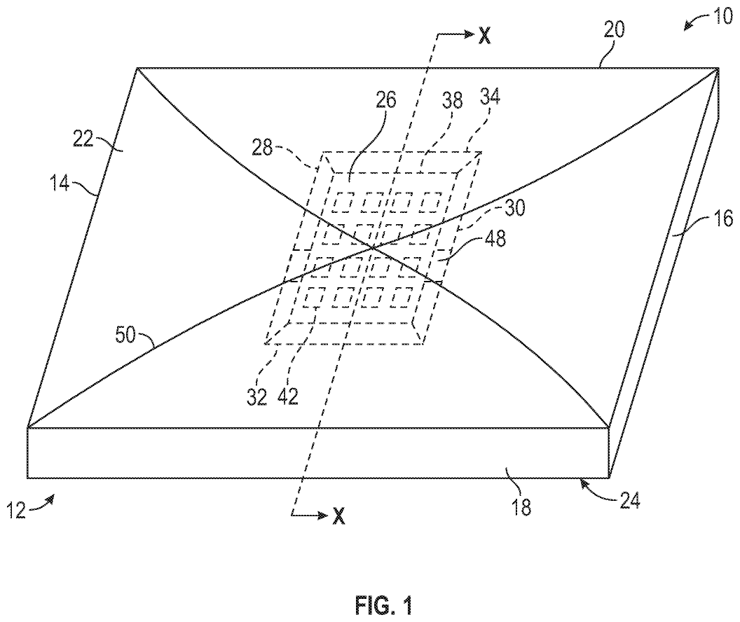

Referring now to the Figures, and, in particular FIG. 1, shown therein is a non-limiting embodiment of the at least one analyte detection sensor 10 constructed in accordance with the presently disclosed and/or claimed inventive concept(s). In such non-limiting embodiment, the at least one analyte detection sensor 10 comprises a substrate 12, an enzyme layer 38, at least one electrode 48, and a sensor membrane cover 50.

The substrate 12 comprises a first side 14, a second side 16, a third side 18, a fourth side 20, a top surface 22, and a bottom surface 24. While shown in FIG. 1 as being substantially rectangular in shape, it should be readily understood to a person having ordinary skill in the art that the substrate 12 can be any shape conducive for accomplishing the presently disclosed and/or claimed inventive concept(s). Such shapes include, but are not limited to, a circle, triangle, square, diamond, pentagon, hexagon, heptagon, octagon, nonagon, decagon, rhombus, trapezoid, rhombus, and parallelogram. The substrate 12 can be constructed of any inert material(s) that accomplish the presently disclosed and/or claimed inventive concept(s), including, without limitation, ceramic(s), nitrocellulose, cellulose acetate, polyethylene terephthalate, polycarbonate, polystyrene, and combinations thereof.

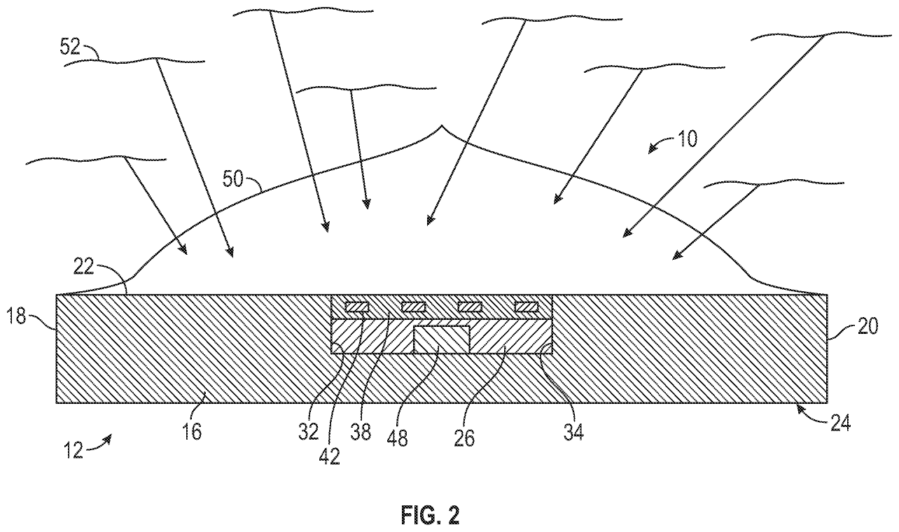

In one non-limiting embodiment, and as shown in FIG. 1, the substrate 12 further comprises a reaction cavity 26. In such embodiment (and as further shown in FIG. 2), the reaction cavity 26 is located between the top surface 22 and bottom surface 24 of the substrate 12. The reaction cavity 26 comprises a first side 28, a second side 30, a third side 32, and a fourth side 34, and an opening (not numbered) located at, on, or near the top surface 22 of the substrate 12, the opening being defined by the first side 28, the second side 30, the third side 32, and the fourth side 34 of the reaction cavity 26. As shown in FIG. 1, the first side 28 of the reaction cavity 26 is substantially parallel to the first side 14 of the substrate 12. Similarly, the second side 30, the third side 32, and the fourth side 34 of the reaction cavity 26 are each substantially parallel to the second side 16, the third side 18, and fourth side 20 of the substrate, respectively. While shown in FIG. 1 as comprising the reaction cavity 26, it should be readily understood to a person having ordinary skill in the art that the substrate 12 need not comprise the reaction cavity 26 to accomplish the presently disclosed and/or claimed inventive concept(s). For instance, as further described herein, the enzyme layer 38, the at least one electrode 48, and the sensor membrane cover 50 may all be located on or substantially on the top surface 22 of the substrate 12. In addition, it should be readily understood to a person having ordinary skill in the art that the substrate 12 may comprise more than one reaction cavity 26 to accomplish the presently disclosed and/or claimed inventive concept(s). For instance, by way of example only, the substrate 12 may comprise 2, 3, 4, 5, 6, 7, 8, 9, 10, 15, 20, 25, 30, 35, 40, 45, 50, 55, 60, 65, 70, 75, 80, 85, 90, 95, or greater than or equal to 100 reaction cavities.

The at least one analyte detection sensor 10 (for instance, by way of example only, at least one amperometric enzyme sensor, such as, for instance, at least one creatinine detection sensor) comprises an enzyme layer 38 that comprises at least one enzyme 42. While shown in FIG. 1 as comprising a single enzyme layer 38, it should be readily understood to a person having ordinary skill in the art that the at least one analyte detection sensor 10 may comprise more than one enzyme layer 38. For instance, by way of example only, the at least one analyte detection sensor 10 may comprise 2, 3, 4, 5, 6, 7, 8, 9, 10, 15, 20, 25, 30, 35, 40, 45, 50, 55, 60, 65, 70, 75, 80, 85, 90, 95, or greater than or equal to 100 enzyme layers. In one non-limiting embodiment, the at least one enzyme 42 comprises and/or consists of creatininase, creatinase, sarcosine oxidase, and/or combinations thereof. The at least one enzyme 42 functions by associating with the analyte of interest (for instance, creatinine) to provide for accurate detection and concentration of the analyte of interest which may be present in a patient's biological fluid sample, which, in one non-limiting embodiment, is a patient's blood sample. As shown in FIG. 1, the enzyme layer 38 comprises at least one immobilized enzyme(s) 42, the enzyme layer 38 being substantially disposed in the reaction cavity 26. However, it should be readily understood to a person having ordinary skill in the art that the enzyme layer 38 may be disposed on the at least one electrode 48 (discussed further hereinbelow), the at least one electrode being located in the reaction cavity 26 or otherwise embedded within the top surface 22 of the substrate 12.

The improved analyte detection sensor(s) 10 may further comprise at least one electrode 48 for the detection of at least one analyte of interest present in a patient's fluid sample. In one non-limiting embodiment and as shown in FIGS. 1 and 2, the at least one electrode 48 rests below the enzyme layer 38 within the reaction cavity 26 of the substrate 12. In one non-limiting embodiment, the at least one electrode 48 comprises an amperometric electrode system that comprises at least one working electrode, at least one counter electrode, and at least one reference electrode in which the enzyme layer 38 is disposed on or substantially on the at least one working electrode. When an analyte of interest (for instance, creatinine) comes into contact with the enzyme layer 38 (which, in one non-limiting embodiment, comprises at least one enzyme 42 including, without limitation, creatininase, creatinase, sarcosine oxidase, and/or combinations thereof), reaction product(s), such as ions and/or detection molecules (such as, by way of example only, hydrogen peroxide) are generated from the reaction of the analyte of interest and the at least one enzyme 42 of the enzyme layer 38. Such reaction product(s), when in contact with the at least one electrode 48, generate an electric current or changes in an electric current (typically measured in amperes or nano amperes) which are readily detected and measured by the at least one electrode 48. The current generated by the at least one electrode 48 is directly proportional to the concentration of the particular analyte of interest being tested, which, in one non-limiting embodiment, is creatinine. A non-limiting embodiment of the at least one electrode 48 that may be utilized in accordance with the presently disclosed and/or claimed inventive concept(s) includes a bare metal electrode. However, other electrode(s) that are capable of functioning as described or otherwise contemplated herein are well known in the art and encompassed by the presently disclosed and/or claimed inventive concept(s). Accordingly, no further discussion thereof is deemed necessary.

The improved analyte detection sensor 10 further comprises at least one sensor membrane cover 50 that, in one non-limiting embodiment, substantially covers the top surface 22 of the substrate 12 (as well as the entirety of the reaction cavity 26, the enzyme layer 38, and the at least one electrode 48) of the improved analyte detection sensor 10. However, it should be readily understood to a person having ordinary skill in the art that the at least one sensor membrane cover 50 need not substantially cover the entirety of the top surface 22 of the substrate 12 to accomplish the presently disclosed and/or claimed inventive concept(s). For instance, when the improved analyte detection sensor array comprises more than one analyte detection sensors 10, each of the analyte detection sensors 10 may be covered by a separate sensor membrane cover(s) 50, which may be constructed of the same or different material(s). In addition, rather than substantially covering the entirety of the top surface 22 of the substrate 12, the at least one sensor membrane cover 50 may cover only a portion of the analyte detection sensor 10. For instance, the sensor membrane cover(s) 50 may only cover the reaction cavity 26 (and enzyme layer 38 and at least one electrode 48) rather than the entirety of the top surface 22 of the substrate 12.

The at least one sensor membrane cover 50 can be constructed of any permeable material capable of accomplishing the presently disclosed and/or claimed inventive concept(s), including, but not limited to, cellulosic and/or polymeric (such as, by way of example, polyurethane) materials, and/or combinations thereof. The at least one sensor cover membrane 50 acts as a permeable cover for the analyte detection sensor 10 in which the at least one biocide (as shown in FIG. 2) diffuses through the at least one sensor cover membrane 50 such that the at least one biocide is in fluid communication the reaction cavity 26, the at least one enzyme layer 38, and/or the at least one electrode 48.

Referring now to FIG. 2, shown therein is a cross-sectional view of the improved analyte detection sensor 10 of FIG. 1 as viewed from the cross-sectional line x of FIG. 1, wherein the analyte detection sensor 10 (and sensor membrane cover(s) 50) is in fluid communication with at least one combined aqueous biocide formulation 52, which is formed from at least two individual aqueous biocides. As previously discussed herein, the at least one combined aqueous biocide formulation 52 functions as a preservative of the at least one improved analyte detection sensor 10 thereby ensuring that the sensor 10 and related systems remain clean whereby the detrimental impacts of contaminant(s) are at least mitigated, if not eliminated in its/their entirety. The functional life of the improved analyte detection sensor 10 is preferably equal to or greater than about 14 days or equal to or greater than about 28 days. However, when the at least one analyte detection sensor 10 comprises a creatinine detection sensor, certain individual biocides (not numbered), such as, by way of example only, CI-MIT, can inactivate the at least one enzyme 42 of the enzyme layer 38 due to the chemical interactions between, for instance, by way of example only, the sulfhydryl/thiol functional groups of the enzyme(s) 42 and the individual biocide. In some instances, the inactivation of the enzyme(s) 42 of the analyte detection sensor 10 (i.e., creatinine detection sensor) occurs in as short as 1-4 days after exposure to individual biocide.

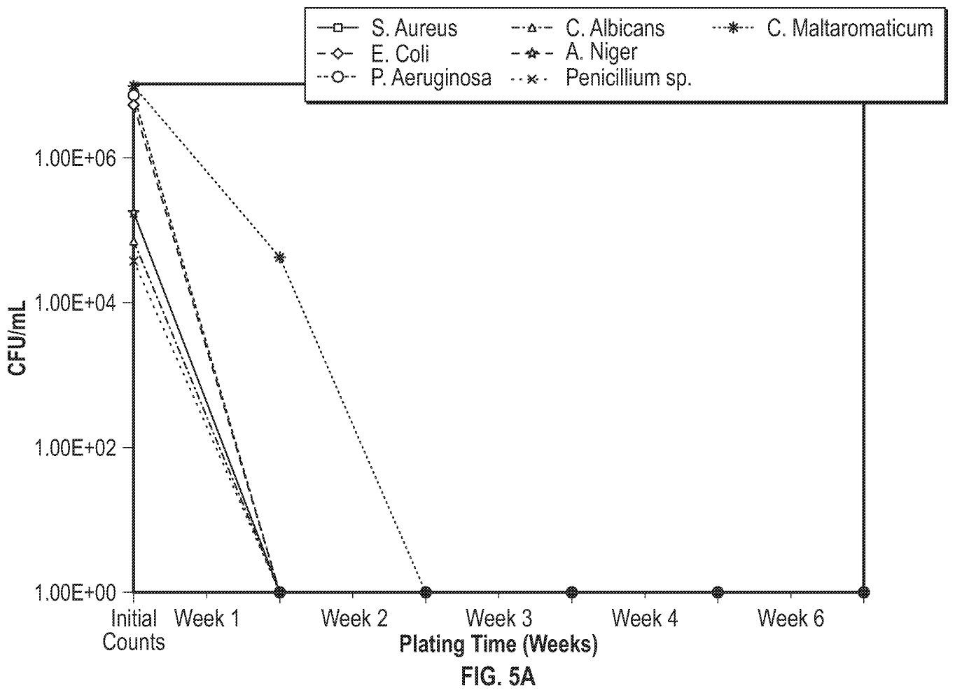

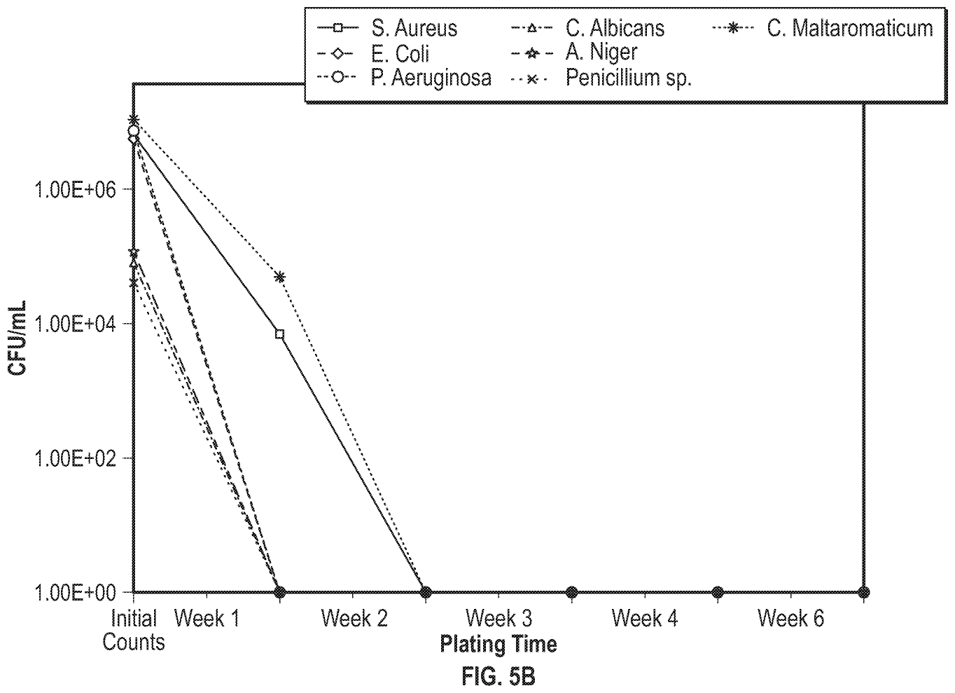

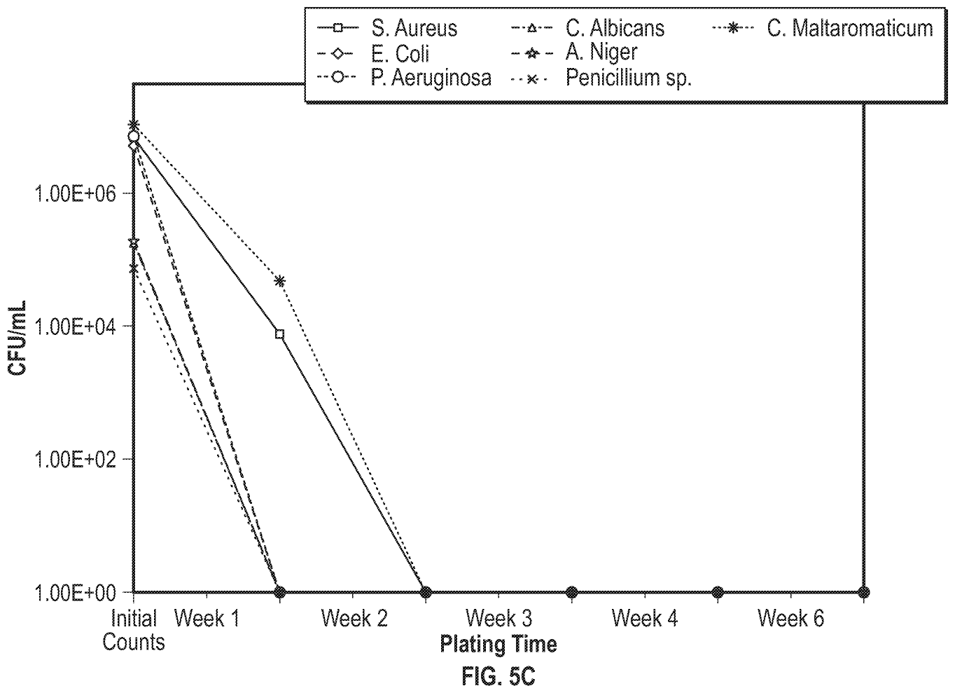

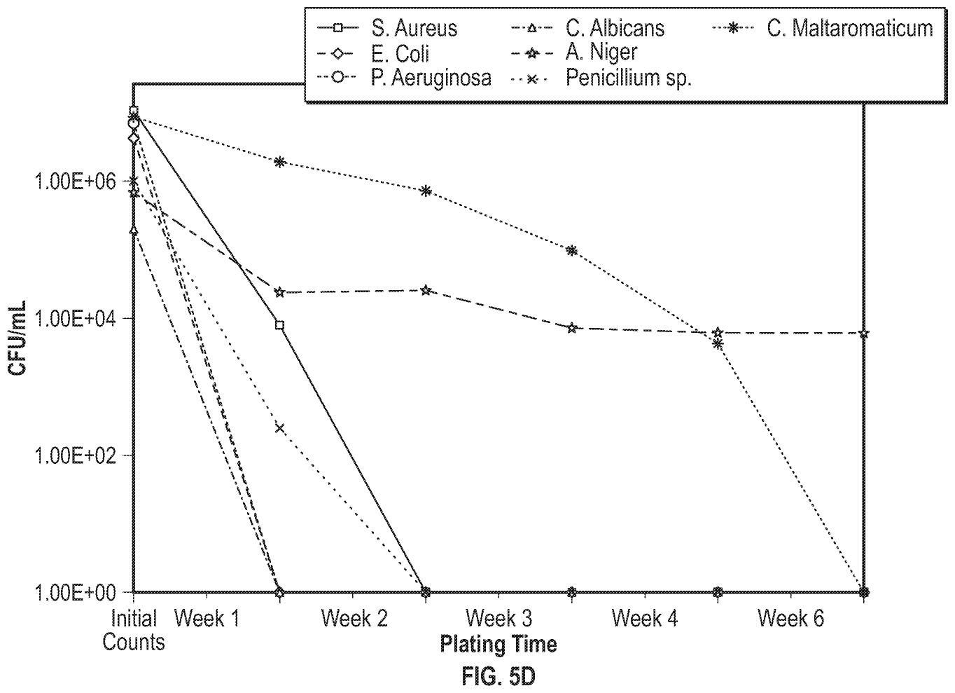

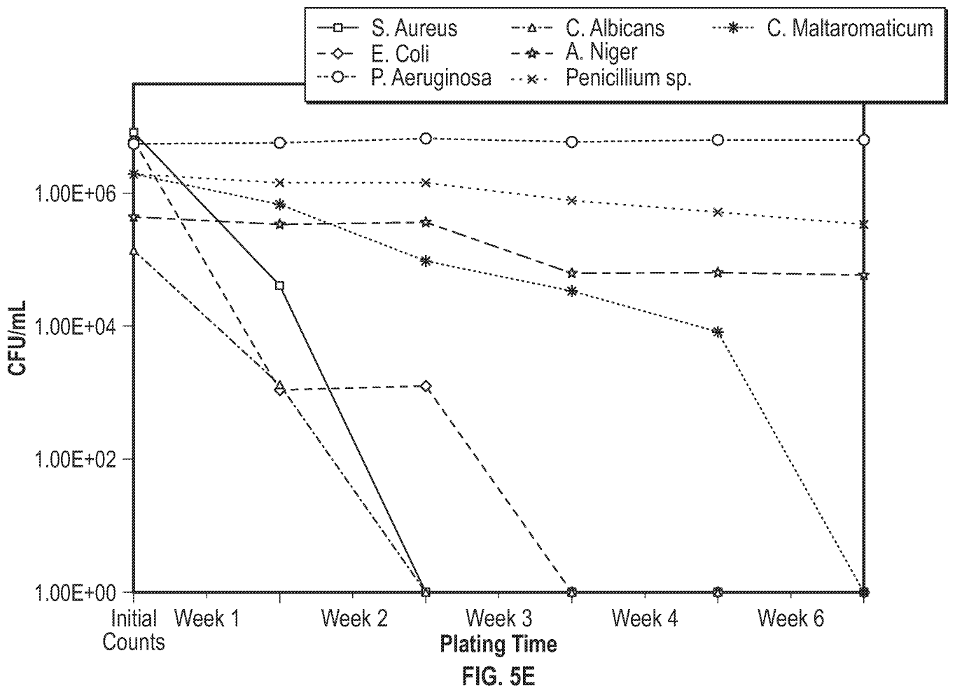

Accordingly, in one non-limiting embodiment, the presently disclosed and/or claimed inventive concept(s) utilize a combination of aqueous biocides, such as, by way of example only, a combination of CI-MIT and Onyxide200 aqueous biocides, which synergistically interact with one another to effectively reduce or eliminate contaminants from the analyte detection sensor 10. In addition, the combination of individual biocides resulting in the synergistic interactions between such biocides allows for the decrease in the concentration of the particular biocide(s) (such as, CI-MIT) that chemically-interact (as described elsewhere herein) with enzyme(s) 42 of the enzyme layer 38 of the analyte detection sensor(s) 10 (i.e., creatinine detection sensor). As a result, the utilization of the combined aqueous biocide formulation 52 thereby increases the functional life of the analyte detection sensor(s) 10 (i.e., creatinine detection sensor). For instance, by utilizing the synergistic combination of Onyxide200 and CI-MIT aqueous biocides (shown in greater details in FIGS. 5A-5E), contaminants are effectively eliminated while the concentration of the individual aqueous CI-MIT biocide component present in the combined aqueous biocide formulation 52 is reduced, thereby resulting in the decrease or elimination of the inactivation of the at least one enzyme 42 of the enzyme layer 38 of the analyte detection sensor 10. The shelf-life of the analyte detection sensor 10 is consequently increased (such as, by way of example, to greater than or equal to about 28 days), while any contaminants that could detrimentally impact the analyte detection sensor 10 are controlled, reduced, mitigated, or eliminated from the analyte detection sensor 10.

The concentrations of the individual aqueous biocides comprising the combined aqueous biocide formulation(s) 52 can be any concentration(s) capable of accomplishing the presently disclosed and/or claimed inventive concept(s). For instance, when the combination aqueous biocide formulation(s) 52 may comprise and/or consist of individual aqueous biocides of Onyxide200 and CI-MIT, the concentration of the Onyxide200 aqueous biocide with respect to the total concentration of the combined aqueous biocide formulation(s) 52 can be (for example, but not by way of limitation) from about 0.1 parts per million (“ppm”) to about 200 ppm, or from about 0.5 ppm to about 150 ppm, or from about 1 ppm to about 100 ppm, or from about 2 ppm to about 95 ppm, or from about 3 ppm to about 90 ppm, or from about 4 ppm to about 85 ppm, or from about 5 ppm to about 80 ppm, or from about 6 ppm to about 75 ppm, or from about 7 ppm to about 70 ppm, or from about 8 ppm to about 65 ppm, or from about 9 ppm to about 60 ppm, or from about 10 ppm to about 55 ppm, or from about 11 ppm to about 50 ppm, or from about 12 ppm to about 45 ppm, or from about 13 ppm to about 40 ppm, or from about 14 ppm to about 35 ppm, or from about 15 ppm to about 30 ppm. In one non-limiting embodiment, the concentration of the Onyxide200 aqueous biocide with respect to the total concentration of the combined aqueous biocide formulation(s) 52 is about 20 ppm. Similarly, when the combined aqueous biocide formulation(s) 52 comprises and/or consists of individual aqueous biocides of Onyxide200 and CI-MIT, the concentration of the CI-MIT aqueous biocide with respect to the total concentration of the combined aqueous biocide formulation(s) 52 can be (for example, but not by way of limitation) from about 0.1 parts per million (“ppm”) to about 200 ppm, or from about 0.5 ppm to about 150 ppm, or from about 0.1 ppm to about 100 ppm, or from about 1 ppm to about 100 ppm, or from about 0.5 ppm to about 50 ppm, or from about 1 ppm to about 20 ppm, or from about 0.1 ppm to about 6 ppm, or from about 0.5 ppm to about 5.5 ppm, or from about 1 ppm to about 5 ppm, or from about 1.5 ppm to about 4.5 ppm, or from about 2 ppm to about 4 ppm, or from about 2.5 ppm to about 3.5 ppm, or equal to about 3 ppm. In one non-limiting embodiment, the concentration of the CI-MIT aqueous biocide with respect to the total concentration of the combined aqueous biocide formulation(s) 52 is from about 1 ppm to about 4 ppm.

One aspect of the presently disclosed and/or claimed inventive concept(s) embodies a method for stabilizing and/or increasing the functional shelf-life of an analyte detection sensor 10 that comprises at least one enzyme layer 38 having at least one enzyme 42. As disclosed elsewhere herein, by way of example only, the analyte detection sensor 10 may comprise and/or consist of a creatinine detection sensor(s) for use within blood gas, electrolyte, and/or metabolite instrumentation. The method comprises the step of introducing a combined aqueous biocide formulation 52 that is formed from a combination of at least two individual aqueous biocides (such as, by way of example only, Onyxide200 and CI-MIT, not numbered), such that the combined aqueous biocide formulation(s) 52 is in fluid communication with, for instance, the at least one enzyme layer 38 of the at least one analyte detection sensor 10. The combined aqueous biocide formulation 52, via diffusion through a sensor membrane cover 50, thereafter comes into fluid communication with the analyte detection sensor 10 whereby the combined aqueous biocide formulation 52 stabilizes and preserves the analyte detection sensor 10 (including increasing the sensor's 10 related shelf-life) by at least: (1) eliminating (or significantly and substantially reducing) any contaminants that detrimentally impact the functioning of the sensor 10; and (2) reducing the concentration of any individual aqueous biocide present within the combined aqueous biocide formulation 52 below a level that results in the inactivation of at least one enzyme 42 (such as, by way of example only, creatinine) present within the at least one enzyme layer 38 of the analyte detection sensor 10.

Experimental Results of Biocide Formulation(s) and Biocide Efficacy

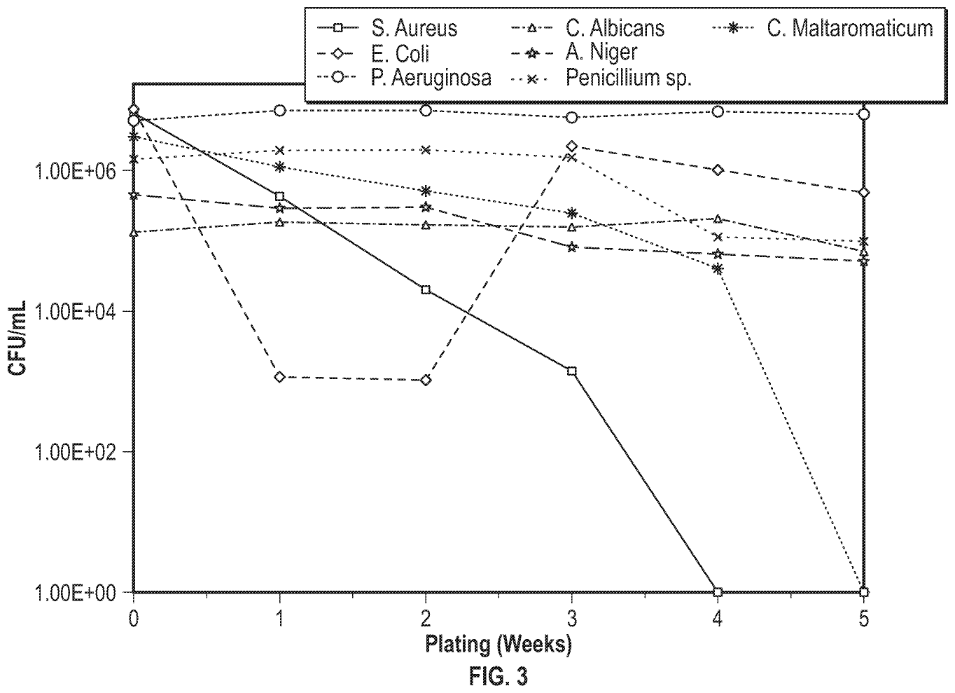

Experimental results of non-limiting embodiments of various biocide formulations (including individual aqueous biocides and combined aqueous biocide formulation(s) 52) constructed and utilized in accordance with the presently disclosed and/or claimed inventive concept(s) are shown in FIGS. 3, 4A-4B, and 5A-5E and are discussed hereinbelow.

Referring now to FIG. 3, shown therein is a graphical plot showing the concentrations (measured in CFU per milliliter) of various contaminants (y-axis), such as, by way of example only, bacteria (including S. aureus, E. coli, P. aeruginosa, and C. maltaromaticum) and fungi (including, C. albicans, A. niger, and Penicillium sp.) over a period of five weeks (x-axis) on plates treated with a concentration of about 20 ppm of the individual aqueous biocide Onyxide200 in accordance with the presently disclosed and/or claimed inventive concept(s). As can be seen from FIG. 3, the use of the individual aqueous biocide Onyxide200 at a concentration of about 20 ppm did not result in a substantial decrease or elimination of the bacteria and/or fungi contaminants, with the concentrations of the vast majority of the contaminants either remaining constant or increasing over the measured five-week period.

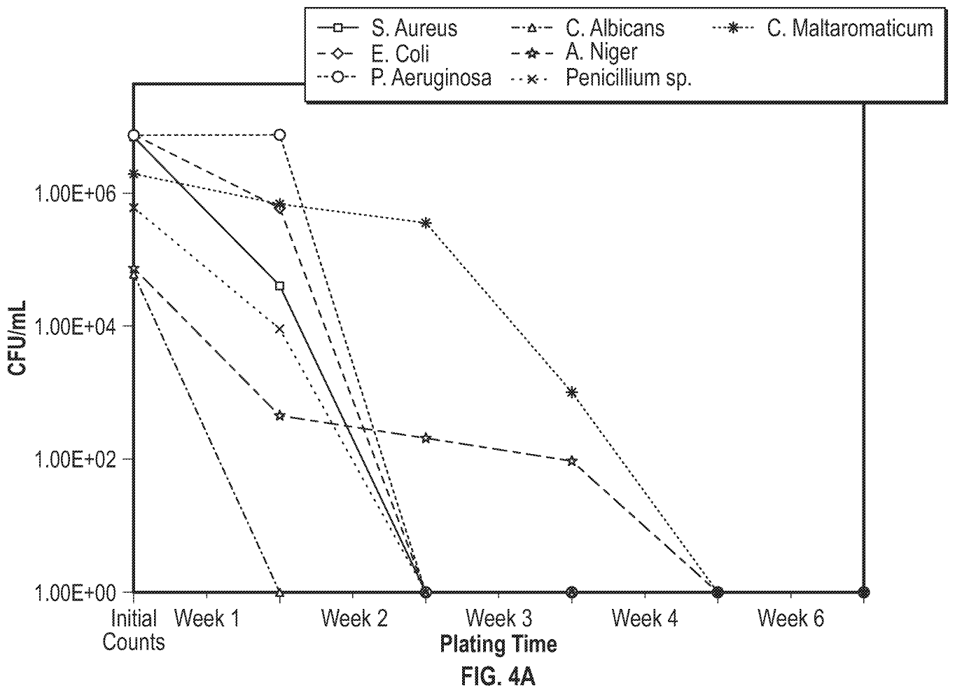

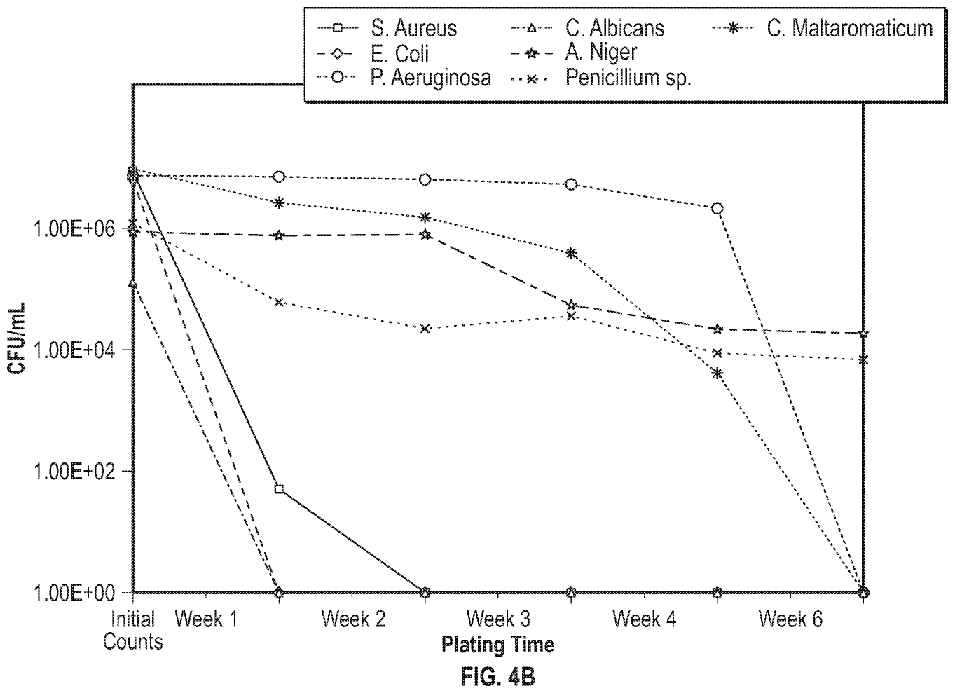

Referring now to FIG. 4A, shown therein is a graphical plot showing the concentrations (measured in CFU per milliliter) of various contaminants (y-axis), such as, by way of example only, bacteria (including S. aureus, E. coli, P. aeruginosa, and C. maltaromaticum) and fungi (including, C. albicans, A. niger, and Penicillium sp.) over a period of six weeks (x-axis) on plates treated with a concentration of about 5 ppm of the individual aqueous biocide CI-MIT in accordance with the presently disclosed and/or claimed inventive concept(s). As can be seen from FIG. 4A, the use of the individual aqueous biocide CI-MIT at a concentration of about 5 ppm eventually resulted in a decrease or elimination of the bacteria and/or fungi contaminants; however, for some contaminants, such decrease and/or elimination of the contaminants was not obtained until week 5 after plating. In addition, as described in greater detail hereinabove, CI-MIT has been shown to inactivate the creatinase enzyme of creatinine detection sensors, with inactivation occurring in as little as 1-4 days after exposure.

Referring now to FIG. 4B, shown therein is a graphical plot showing the concentrations (measured in CFU per milliliter) of various contaminants (y-axis), such as, by way of example only, bacteria (including S. aureus, E. coli, P. aeruginosa, and C. maltaromaticum) and fungi (including, C. albicans, A. niger, and Penicillium sp.) over a period of six weeks (x-axis) on plates treated with a concentration of about 1 ppm of the individual aqueous biocide CI-MIT in accordance with the presently disclosed and/or claimed inventive concept(s). As can be seen from FIG. 4B, the use of the individual aqueous biocide CI-MIT at a concentration of about 1 ppm eventually resulted in a decrease or elimination of only some of the bacteria and/or fungi contaminants; however, for some contaminants, such decrease and/or elimination of the contaminants was not obtained until after week 6 of plating and some contaminants were not significantly reduced at all.

Referring now to FIG. 5A, shown therein is a graphical plot showing the concentrations (measured in CFU per milliliter) of various contaminants (y-axis), such as, by way of example only, bacteria (including S. aureus, E. coli, P. aeruginosa, and C. maltaromaticum) and fungi (including, C. albicans, A. niger, and Penicillium sp.) over a period of six weeks (x-axis) on plates treated with a combined aqueous biocide formulation comprising concentrations of about 20 ppm of Onyxide200 biocide and about 4 ppm of Cl-MIT biocide in accordance with the presently disclosed and/or claimed inventive concept(s). As can be clearly seen in FIG. 5A, the combined aqueous biocide formulation comprising about 20 ppm Onyxide200 and about 4 ppm CI-MIT allows the individual biocides to synergistically function to decrease and eliminate all of the tested contaminants within two and a half weeks after plating. This is synergistic effect allows for a significant increase in the formulation's efficacy for contaminant removal over the individual component biocides (Onyxide200 and CI-MIT) which comprise the formulation.

Referring now to FIG. 5B, shown therein is a graphical plot showing the concentrations (measured in CFU per milliliter) of various contaminants (y-axis), such as, by way of example only, bacteria (including S. aureus, E. coli, P. aeruginosa, and C. maltaromaticum) and fungi (including, C. albicans, A. niger, and Penicillium sp.) over a period of six weeks (x-axis) on plates treated with a combined aqueous biocide formulation comprising concentrations of about 20 ppm of Onyxide200 biocide and about 3 ppm of Cl-MIT biocide in accordance with the presently disclosed and/or claimed inventive concept(s). As can be clearly seen in FIG. 5B, the synergistic effect resulting from the combination of the individual biocides Onyxide200 and CI-MIT is still realized when the concentration of the individual biocide Cl-MIT component of the combined aqueous biocide formulation is reduced to 3 ppm (from 4 ppm as shown in FIG. 5A). In addition, this reduction in concentration of the individual aqueous biocide CI-MIT component further serves to preserve the integrity and functionality of the creatinine detection sensor, as lower concentrations of the aqueous Cl-MIT biocide component (such as, by way of example, a reduction of about 50% in the amount of CI-MIT) within the combined aqueous biocide formulation do not inactivate the creatinase enzyme.

Referring now to FIG. 5C, shown therein is a graphical plot showing the concentrations (measured in CFU per milliliter) of various contaminants (y-axis), such as, by way of example only, bacteria (including S. aureus, E. coli, P. aeruginosa, and C. maltaromaticum) and fungi (including, C. albicans, A. niger, and Penicillium sp.) over a period of six weeks (x-axis) on plates treated with a combined aqueous biocide formulation comprising concentrations of about 20 ppm of Onyxide200 biocide and about 2 ppm of Cl-MIT biocide in accordance with the presently disclosed and/or claimed inventive concept(s). As can be clearly seen in FIG. 5C, the synergistic effect resulting from the combination of the individual biocides Onyxide200 and CI-MIT is still realized when the concentration of the individual biocide CI-MIT component of the combined aqueous biocide formulation is reduced to 2 ppm (from 4 ppm as shown in FIG. 5A and 3 ppm as shown in FIG. 5B). In addition, this reduction in concentration of the individual aqueous biocide CI-MIT component further serves to preserve the integrity and functionality of the creatinine detection sensor, as lower concentrations of the aqueous CI-MIT biocide component within the combined aqueous biocide formulation do not inactivate the creatinase enzyme.

Referring now to FIG. 5D, shown therein is a graphical plot showing the concentrations (measured in CFU per milliliter) of various contaminants (y-axis), such as, by way of example only, bacteria (including S. aureus, E. coli, P. aeruginosa, and C. maltaromaticum) and fungi (including, C. albicans, A. niger, and Penicillium sp.) over a period of six weeks (x-axis) on plates treated with a combined aqueous biocide formulation comprising concentrations of about 20 ppm of Onyxide200 biocide and about 1 ppm of Cl-MIT biocide in accordance with the presently disclosed and/or claimed inventive concept(s). As can be clearly seen in FIG. 5D, the synergistic effect resulting from the combination of the individual biocides Onyxide200 and CI-MIT is not realized when the concentration of the individual biocide CI-MIT component of the combined aqueous biocide formulation is reduced to 1 ppm (i.e., the combined aqueous biocide formulation comprising about 20 ppm aqueous Onyxide200 and about 1 ppm aqueous CI-MIT does not exhibit any discernible synergistic effect(s) and is not effective at removing contaminants—as certain contaminants are still present well after week 6 of plating).

Referring now to FIG. 5E, shown therein is a graphical plot showing the concentrations (measured in CFU per milliliter) of various contaminants (y-axis), such as, by way of example only, bacteria (including S. aureus, E. coli, P. aeruginosa, and C. maltaromaticum) and fungi (including, C. albicans, A. niger, and Penicillium sp.) over a period of six weeks (x-axis) on plates treated with a combined aqueous biocide formulation comprising concentrations of about 20 ppm of Onyxide200 biocide and about 0.5 ppm of Cl-MIT biocide in accordance with the presently disclosed and/or claimed inventive concept(s). As can be clearly seen in FIG. 5E, the synergistic effect resulting from the combination of the individual biocides Onyxide200 and CI-MIT is not realized when the concentration of the individual biocide CI-MIT component of the combined aqueous biocide formulation is reduced to 0.5 ppm (i.e., the combined aqueous biocide formulation comprising about 20 ppm aqueous Onyxide200 and about 0.5 ppm aqueous CI-MIT does not exhibit any discernible synergistic effect(s) and is not effective at removing contaminants—as a multitude of contaminants are still present well after week 6 of plating).

### Non-Limiting Illustrative Embodiments of the Inventive Concept(s)

Illustrative embodiment 1. An aqueous biocide composition, comprising a first aqueous biocide, the first aqueous biocide comprising a first predetermined concentration of hexahydro 1,3,5-tris(2-hydroxy ethyl)-S-triazine; and a second aqueous biocide, the second aqueous biocide comprising a second predetermined concentration of an isothiazolinone-based biocide.

Illustrative embodiment 2. The aqueous biocide composition of illustrative embodiment 1, wherein the isothiazolinone-based biocide is 5-chloro-2-methylisothiazol-3(2H)-one.

Illustrative embodiment 3. The aqueous biocide composition of illustrative embodiment 1, wherein the isothiazolinone-based biocide is selected from the group consisting of methylisothiazolinone, octylisothiazolinone, dichlorooctylisothiaolinone, butylbenzisothiazolinone, and combinations thereof

Illustrative embodiment 4. The aqueous biocide composition of any one of illustrative embodiments 1-3, wherein the first predetermined concentration is in a range of from about 1 ppm to about 100 ppm of hexahydro 1,3,5-tris(2-hydroxy ethyl)-S-triazine, and the second predetermined concentration is in a range of from about 1 ppm to about 100 ppm of the isothiazolinone-based biocide. For example (but not by way of limitation), the first predetermined concentration is about 20 ppm of hexahydro 1,3,5-tris(2-hydroxy ethyl)-S-triazine, and the second predetermined concentration is in a range of from about 2 ppm to about 4 ppm of the isothiazolinone-based biocide.

Illustrative embodiment 5. The aqueous biocide composition of any one of illustrative embodiments 1-4, further defined as a clinical chemistry reagent solution for a clinical laboratory instrument containing at least one biosensor, and wherein the aqueous biocide composition does not substantially affect a biological activity of the at least one biosensor of the clinical laboratory instrument.

Illustrative embodiment 6. A system, comprising: an aqueous biocide composition, comprising: (i) a first aqueous biocide, the first aqueous biocide comprising a first predetermined concentration of hexahydro 1,3,5-tris(2-hydroxy ethyl)-S-triazine, and a second aqueous biocide, the second aqueous biocide comprising a second predetermined concentration of an isothiazolinone-based biocide; (ii) at least one biosensor having a biological activity; and wherein when the aqueous biocide composition is applied to the at least one biosensor, the aqueous biocide composition does not substantially affect the biological activity of the at least one biosensor.

Illustrative embodiment 7. The system of illustrative embodiment 6, wherein the isothiazolinone-based biocide is 5-chloro-2-methylisothiazol-3(2H)-one.

Illustrative embodiment 8. The system of illustrative embodiment 6, wherein the isothiazolinone-based biocide is selected from the group consisting of methylisothiazolinone, octylisothiazolinone, dichlorooctylisothiaolinone, butylbenzisothiazolinone, and combinations thereof

Illustrative embodiment 9. The system of any one of illustrative embodiments 6-8, wherein the first predetermined concentration is in a range of from about 1 ppm to about 100 ppm of hexahydro 1,3,5-tris(2-hydroxy ethyl)-S-triazine, and the second predetermined concentration is in a range of from about 1 ppm to about 100 ppm of the isothiazolinone-based biocide. For example (but not by way of limitation), the first predetermined concentration is about 20 ppm of hexahydro 1,3,5-tris(2-hydroxy ethyl)-S-triazine, and the second predetermined concentration is in a range of from about 2 ppm to about 4 ppm of the isothiazolinone-based biocide.

Illustrative embodiment 10. The system of any one of illustrative embodiments 6-9, wherein the at least one biosensor comprises an enzyme having a biological activity, and wherein the aqueous biocide composition does not substantially affect the biological activity of the enzyme such that at least 70% of the enzyme's biological activity is retained for at least 6 days following initial contact with the aqueous biocide composition.

Illustrative embodiment 11. The system of illustrative embodiment 10, wherein the at least one biosensor is a creatinine detection sensor.

Illustrative embodiment 12. The method of illustrative embodiment 11, wherein the at least one enzyme of the creatinine detection sensor is selected from the group consisting of creatininase, creatinase, sarcosine oxidase, and combinations thereof.

Illustrative embodiment 13. A method for mitigating and/or inhibiting inactivation of at least one enzyme of at least one biosensor of a blood gas, electrolyte, and/or metabolite instrument, the method comprising the steps of: contacting the at least one biosensor with an aqueous biocide composition, wherein the aqueous biocide composition comprises a first aqueous biocide, the first aqueous biocide comprising a first predetermined concentration of hexahydro 1,3,5-tris(2-hydroxy ethyl)-S-triazine and a second aqueous biocide, the second aqueous biocide comprising a second predetermined concentration of an isothiazolinone-based biocide; and wherein the aqueous biocide composition does not substantially affect a biological activity of the at least one enzyme of the at least one biosensor.

Illustrative embodiment 14. The method of illustrative embodiment 13, wherein the isothiazolinone-based biocide is 5-chloro-2-methylisothiazol-3(2H)-one.

Illustrative embodiment 15. The method of illustrative embodiment 13, wherein the isothiazolinone-based biocide is selected from the group consisting of methylisothiazolinone, octylisothiazolinone, dichlorooctylisothiaolinone, butylbenzisothiazolinone, and combinations thereof

Illustrative embodiment 16. The method of any one of illustrative embodiments 13-15, wherein the first predetermined concentration is in a range of from about 1 ppm to about 100 ppm of hexahydro 1,3,5-tris(2-hydroxy ethyl)-S-triazine, and the second predetermined concentration is in a range of from about 1 ppm to about 100 ppm of the isothiazolinone-based biocide. For example (but not by way of limitation), the first predetermined concentration is about 20 ppm of hexahydro 1,3,5-tris(2-hydroxy ethyl)-S-triazine, and the second predetermined concentration is in a range of from about 2 ppm to about 4 ppm of the isothiazolinone-based biocide.

Illustrative embodiment 17. The method of any one of illustrative embodiments 13-16, wherein the at least one biosensor is a creatinine detection sensor.

Illustrative embodiment 18. The method of illustrative embodiment 17, wherein the at least one enzyme is selected from the group consisting of creatininase, creatinase, sarcosine oxidase, and combinations thereof.

Illustrative embodiment 19. The method of any one of illustrative embodiments 13-18, wherein the aqueous biocide composition does not substantially affect a biological activity of the at least one enzyme of the at least one biosensor such that at least 70% of the enzyme's biological activity is retained for at least 6 days following initial contact with the aqueous biocide composition

Other illustrative embodiments are outlined below.

An aqueous biocide composition that removes at least one contaminant from at least one analyte detection sensor, comprising: a first aqueous biocide, the first aqueous biocide comprising a first predetermined concentration of hexahydro 1,3,5-tris(2-hydroxy ethyl)-S-triazine; and a second aqueous biocide, the second aqueous biocide comprising a second predetermined concentration of 5-chloro-2-methylisothiazol-3(2H)-one, wherein the first aqueous biocide and the second aqueous biocide synergistically interact with one another to remove at least one contaminant from at least one analyte detection sensor.

The aqueous biocide composition, wherein the first predetermined concentration is about 20 ppm of hexahydro 1,3,5-tris(2-hydroxy ethyl)-S-triazine.

The aqueous biocide composition, wherein the second predetermined concentration is in a range of from about 2 ppm to about 4 ppm of 5-chloro-2-methylisothiazol-3(2H)-one.

The aqueous biocide composition, wherein the at least one contaminant is selected from the group consisting bacteria, fungi, and combinations thereof.

The aqueous biocide composition, wherein the bacteria is selected from group consisting of S. aureus, E. coli, P. aeruginosa, C. maltaromaticum, and combinations thereof.

The aqueous biocide composition, wherein the fungi is selected from the group consisting of C. albicans, A. niger, Penicillium sp., and combinations thereof.

The aqueous biocide composition, wherein the at least one analyte detection sensor comprises an amperometric detection sensor.

The aqueous biocide composition, wherein the amperometric detection sensor comprises a creatinine detection sensor.

The aqueous biocide composition, wherein the creatinine detection sensor further comprises at least one enzyme layer.

The aqueous biocide composition, wherein the at least one enzyme layer comprises at least one enzyme selected from the group consisting of creatininase, creatinase, sarcosine oxidase, and/or combinations thereof.

A method for removing one or more contaminants from at least one analyte detection sensor of a blood gas, electrolyte, and/or metabolite instrument, the method comprising the steps of: introducing an aqueous biocide composition, the aqueous biocide composition comprising a first aqueous biocide, the first aqueous biocide comprising a first predetermined concentration of hexahydro 1,3,5-tris(2-hydroxy ethyl)-S-triazine and a second aqueous biocide, the second aqueous biocide comprising a second predetermined concentration of 5-chloro-2-methylisothiazol-3(2H)-one, such that the at least one aqueous biocide is in fluid communication with at least one analyte detection sensor, the at least analyte detection sensor comprising: a substrate, the substrate comprising a top surface and a bottom surface; an enzyme layer, the enzyme layer comprising at least one enzyme, wherein the enzyme layer is disposed on the top surface of the substrate; at least one electrode, wherein the at least one electrode is disposed on the top surface of the substrate such that the at least one electrode is substantially covered by the enzyme layer; and a sensor membrane cover, the sensor membrane being substantially disposed over the top surface of the substrate, wherein the sensor membrane cover is configured to allow for the diffusion of the aqueous biocide composition through the sensor cover membrane; contacting the at least one analyte detection sensor with the aqueous biocide composition that has diffused through the sensor membrane cover, such that the aqueous biocide composition associates with an eliminates one or more contaminants present on or within the enzyme layer.

The method, wherein the first predetermined concentration is about 20 ppm of hexa hydro 1,3,5-tris(2-hydroxy ethyl)-S-triazine.

The method, wherein the second predetermined concentration is in a range of from about 2 ppm to about 4 ppm of 5-chloro-2-methylisothiazol-3(2H)-one.

The method, wherein the at least one contaminant is selected from the group consisting bacteria, fungi, and combinations thereof.

The method, wherein the bacteria is selected from group consisting of S. aureus, E. coli, P. aeruginosa, C. maltaromaticum, and combinations thereof.

The method, wherein the fungi is selected from the group consisting of C. albicans, A. niger, Penicillium sp., and combinations thereof.

The method, wherein the at least one analyte detection sensor is a creatinine detection sensor.

The method, wherein the at least on enzyme is selected from the group consisting of creatininase, creatinase, sarcosine oxidase, and combinations thereof.

Thus, in accordance with the presently disclosed and/or claimed inventive concept(s), there have been provided compositions, devices, kits, and methods of improved (or for improving) biocide formulation(s) for use in at least one analyte detection sensor(s) and/or diagnostic assay(s). As described herein, the presently disclosed and/or claimed inventive concept(s) relate to non-limiting embodiments of an improved biocide formulation(s) that comprises and/or consists of at least two biocide compositions that synergistically work together to mitigate and/or inhibit the inactivation of at least one enzyme(s) present on and/or in a sensor(s) utilized for analyte(s) detection, such as, by way of example only, a creatinine detection sensor. Such presently disclosed and/or claimed inventive concept(s) fully satisfy the objectives and advantages set forth hereinabove. Although the presently disclosed and/or claimed inventive concept(s) has been described in conjunction with the specific drawings, experimentation, results and language set forth hereinabove, it is evident that many alternatives, modifications, and variations will be apparent to those skilled in the art. Accordingly, it is intended to embrace all such alternatives, modifications, and variations that fall within the spirit and broad scope of the presently disclosed and/or claimed inventive concept(s).

1. An aqueous biocide composition, comprising:
a first aqueous biocide, the first aqueous biocide comprising a first predetermined concentration of hexahydro 1,3,5-tris(2-hydroxy ethyl)-S-triazine; and
a second aqueous biocide, the second aqueous biocide comprising a second predetermined concentration of an isothiazolinone-based biocide.

2. The aqueous biocide composition of claim 1, wherein the isothiazolinone-based biocide is 5-chloro-2-methylisothiazol-3(2H)-one.

3. The aqueous biocide composition of claim 1, wherein the isothiazolinone-based biocide is selected from the group consisting of methylisothiazolinone, octylisothiazolinone, dichlorooctylisothiaolinone, butylbenzisothiazolinone, and combinations thereof

4. The aqueous biocide composition of claim 1, wherein the first predetermined concentration is in a range of from about 1 ppm to about 100 ppm of hexahydro 1,3,5-tris(2-hydroxy ethyl)-S-triazine, and the second predetermined concentration is in a range of from about 1 ppm to about 100 ppm of the isothiazolinone-based biocide.

5. The aqueous biocide composition of claim 1, further defined as a clinical chemistry reagent solution for a clinical laboratory instrument containing at least one biosensor, and wherein the aqueous biocide composition does not substantially affect a biological activity of the at least one biosensor of the clinical laboratory instrument.

6. A system, comprising:
an aqueous biocide composition, comprising:
a first aqueous biocide, the first aqueous biocide comprising a first predetermined concentration of hexahydro 1,3,5-tris(2-hydroxy ethyl)-S-triazine; and
a second aqueous biocide, the second aqueous biocide comprising a second predetermined concentration of an isothiazolinone-based biocide;
at least one biosensor having a biological activity; and
wherein when the aqueous biocide composition is applied to the at least one biosensor, the aqueous biocide composition does not substantially affect the biological activity of the at least one biosensor.

7. The system of claim 6, wherein the isothiazolinone-based biocide is 5-chloro-2-methylisothiazol-3(2H)-one.

8. The system of claim 6, wherein the isothiazolinone-based biocide is selected from the group consisting of methylisothiazolinone, octylisothiazolinone, dichlorooctylisothiaolinone, butylbenzisothiazolinone, and combinations thereof

9. The system of claim 6, wherein the first predetermined concentration is in a range of from about 1 ppm to about 100 ppm of hexahydro 1,3,5-tris(2-hydroxy ethyl)-S-triazine, and the second predetermined concentration is in a range of from about 1 ppm to about 100 ppm of the isothiazolinone-based biocide.

10. The system of claim 6, wherein the at least one biosensor comprises an enzyme having a biological activity, and wherein the aqueous biocide composition does not substantially affect the biological activity of the enzyme such that at least 70% of the enzyme's biological activity is retained for at least 6 days following initial contact with the aqueous biocide composition.

11. The system of claim 10, wherein the at least one biosensor is a creatinine detection sensor.

12. The system of claim 11, wherein the at least one enzyme of the creatinine detection sensor is selected from the group consisting of creatininase, creatinase, sarcosine oxidase, and combinations thereof.

13. A method for mitigating and/or inhibiting inactivation of at least one enzyme of at least one biosensor of a blood gas, electrolyte, and/or metabolite instrument, the method comprising the steps of:
contacting the at least one biosensor with an aqueous biocide composition, wherein the aqueous biocide composition comprises:
a first aqueous biocide, the first aqueous biocide comprising a first predetermined concentration of hexahydro 1,3,5-tris(2-hydroxy ethyl)-S-triazine; and
a second aqueous biocide, the second aqueous biocide comprising a second predetermined concentration of an isothiazolinone-based biocide; and
wherein the aqueous biocide composition does not substantially affect a biological activity of the at least one enzyme of the at least one biosensor.

14. The method of claim 13, wherein the isothiazolinone-based biocide is 5-chloro-2-methylisothiazol-3(2H)-one.

15. The method of claim 13, wherein the isothiazolinone-based biocide is selected from the group consisting of methylisothiazolinone, octylisothiazolinone, dichlorooctylisothiaolinone, butylbenzisothiazolinone, and combinations thereof

16. The method of claim 13, wherein the first predetermined concentration is in a range of from about 1 ppm to about 100 ppm of hexahydro 1,3,5-tris(2-hydroxy ethyl)-S-triazine, and the second predetermined concentration is in a range of from about 1 ppm to about 100 ppm of the isothiazolinone-based biocide.

17. The method of claim 13, wherein the at least one biosensor is a creatinine detection sensor.

18. The method of claim 17, wherein the at least one enzyme is selected from the group consisting of creatininase, creatinase, sarcosine oxidase, and combinations thereof.

19. The method of claim 13, wherein the aqueous biocide composition does not substantially affect a biological activity of the at least one enzyme of the at least one biosensor such that at least 70% of the enzyme's biological activity is retained for at least 6 days following initial contact with the aqueous biocide composition.
